(19) United States
(12) Patent Application Publication
(10) Pub. No.: US 2009/0033124 A1
(43) Pub. Date: Feb. 5, 2009

(54) Wind Bulkhead Device For A Motor Vehicle Provided With An Open Bodywork

(75) Inventors: Thomas Benzing, Wildberg (DE); Bernhard Gloss, Brackenheim (DE); Juergen Hugo Weingarth, Sindelfingen (DE); Katrin Susan Weingarth, Sindelfingen (DE); Matthias Weingarth, Sindelfingen (DE); Christoph Weingarth, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/792,241

(22) PCT Filed: Nov. 29, 2005
(86) PCT No.: PCT/EP05/12739

§ 371 Date: Feb. 1, 2008

(30) Foreign Application Priority Data
Dec. 4, 2004 (DE) 10 2004 058 505.9

(51) Int. Cl. B60J 1/20

(52) U.S. Cl. 296/180.5

(57) ABSTRACT

A wind bulkhead device for motor vehicles provided with an open bodywork is described. The wind bulkhead can be pivoted between an erected bulkhead position and a rear folded-down position, and covers the space between the head restraints of adjacent seats, in particular adjacent rear seats. The wind bulkhead is stabilized via the head restraints in their extended position by an of elastic knock-over resistance element and, when the head restraints are lowered, can be automatically pivoted from its bulkhead position, in which it is preferably erected manually, into its folded-down position.

### CROSS REFERENCE TO RELATED APPLICATIONS

This application is a National Stage of PCT International Application No. PCT/EP2005/012739, filed Nov. 29, 2005, which claims priority under 35 U.S.C. § 119 to German Patent Application No. 10 2004 058 505.9 filed Dec. 4, 2004, the entire disclosures of which are herein expressly incorporated by reference.

### BACKGROUND AND SUMMARY OF THE INVENTION

The invention relates to a wind bulkhead device for a motor vehicle provided with an open bodywork, two seats disposed in the transverse direction of the vehicle and head restraints assigned to the vehicle seats, the wind bulkhead being between the head restraints.

Wind bulkhead devices of the abovementioned type are known from German Patent Document DE 42 39 428 A1, in which the four-seater vehicle which is provided with an open bodywork and is designed as a convertible has, on the front side, a wind deflector protruding as an extension of the windshield and, on the rear side, a wind bulkhead extending between the head restraints of the rear seats. The wind deflector is formed by an elastic net spread out in a frame, and an elastic, fine-mesh net is likewise provided as the wind bulkhead, which net covers the space between the head restraints and, extending between the side walls of the head restraints, is fastened to the head restraints.

It is known from German Patent Document DE 196 32 352 B4, for a two-seater vehicle provided with an open bodywork, to arrange a roll bar fixed to the rear of the seats, the roll bar shaped as a tubular frame running in the transverse direction, has in the region of the seats above the belt line of the vehicle, upwardly arched bar sections which are connected via a central web running level with the belt line. The space located above the central web between the bar sections is blocked off by a transparent screen arranged vertically, which, together with net structures which are spread out in the bar sections, forms a wind bulkhead, the central part of which formed by the screen, and can be removed from its latching position with respect to the bar sections.

A further wind bulkhead device is the subject matter of German Patent Documents DE 100 61 652 A1 and is provided for a two-seater vehicle having an open bodywork and a roll bar, the frame structure of which has upwardly arched bar sections in the region behind the seats. The bar sections are used for the latching fixing of a wind bulkhead which has a frame spanning the vehicle in the transverse direction, and can be latched against the bar sections laterally covering the latter. The wind bulkhead has a net that is spread out, and is constructed from two frame halves. With reference to the wind bulkhead which is fixed with respect to the bar sections, the frame halves are connected pivotably to each other about a vertical axis, and can be locked with respect to each other in their extended position, the pivoting into this extended position and the associated latching in relation to the bar sections also bringing about the fixing of the removable wind bulkhead.

The present invention provides a further wind bulkhead device for motor vehicles having an open bodywork, in which the wind bulkhead covers the space between head restraints assigned to the seats and can be handled in a particularly expedient manner.

According to the invention, exemplary features of the device include a wind bulkhead device which comprises a wind bulkhead that can be repositioned between an upright bulkhead position and a folded-down position, in which it is pivoted downward to the rear, said wind bulkhead interacting with the side surfaces of the head restraints, which are provided laterally adjacent thereto, in such a manner that knock-over resistance elements are provided, which are assigned to the side surfaces of the head restraints or are formed thereby, and which secure the wind bulkhead in at least one direction in its bulkhead position.

The securing can be achieved in a particularly simple manner and without optical disadvantages in that the side surfaces are formed and/or supported elastically at least in some regions transversely to their extent and, in said elastic regions, protrude into the pivoting path of the wind bulkhead, i.e. are pushed aside when the wind bulkhead is repositioned into its bulkhead position or in the opposite direction and, by springing back, pass into an overlapping position with the wind bulkhead.

In this overlapping position, the edge of the wind bulkhead can be engaged over, or an engagement in an edge-side undercut of the wind bulkhead can also take place if, for example, its frame is arched concavely inward.

By different shaping of the side surfaces and/or by different degrees of flexibility in the region of the side surfaces, it is also possible for them to firstly provide a stop limitation, i.e. to define the pivoting path in the erection direction in a manner limited by stops, and, in the opposite direction, just to provide a knock-over resistance method for securing against an unintentional folding-down operation.

The stop limitation can secondly also be provided independently of the configuration of the head restraints and the side surfaces thereof and can be formed, for example, by a corresponding rotational stop assigned to the pivot axis of the wind bulkhead. Particularly in the case of a hinged arrangement of the wind bulkhead, a rotational stop of this type can be integrated into said hinge arrangement in a simple manner. In particular, it is also possible for adjustment springs, preferably leg springs, to be integrated into the hinge arrangement, so that by using the springs the wind bulkhead is loaded in the direction of its bulkhead position or in the opposite direction to its folded-down position, with the latter constituting a preferred solution in conjunction with the capability of erecting the wind bulkhead manually.

In particular in conjunction with head restraints which can be extended with respect to the backrests and can be lowered into the backrests, in the exemplary embodiment according to the invention the pivoting movement of the wind bulkhead, particularly into its folded-down position, can also be connected to the lowering of the head restraints, if the wind bulkhead is spring-loaded in the direction of the folded-down position and the wind bulkhead and/or the head restraints, in the region of their side surfaces facing the wind bulkhead, can be correspondingly moved in the vertical direction without intersecting. This can also be achieved in a particularly simple manner in that the side surfaces of the head restraints and/or those edge zones of the wind bulkhead which face the side surfaces are inclined with respect to one another in such a manner that, with the lowering movement of the head restraints, the lateral distance between head restraints and the edge of the wind bulkhead is enlarged in the respectively provided overlapping region and therefore results in a corresponding free movement.

Within the context of the invention, the head restraints can be configured, in particular with respect to their stability, but also with regard to optionally provided devices for the active displacement between extended and lowered positions and associated latching, such that they satisfy the roll bar function. Owing to the head restraints being movable in relation to the folded-down wind bulkhead without intersecting, mutual obstructions are prevented, even in the event of an active triggering of the roll bar function.

In accordance with the dual function of the head restraints roll bar, the invention also includes embodiments, in which a respective roll bar is configured in such a manner that it forms a head restraint, and therefore the solution according to the invention is also suitable as a method of retrofitting vehicles which have a roll bar.

The solution according to the invention is advantageously usable even when there is a functional separation of head restraints and roll bar, as it is also possible according to embodiments for the invention for the supporting function of the wind bulkhead, in its bulkhead position, to be taken over by the roll bar, which roll bar can be configured for this purpose—analogously to the head restraints—in side regions facing the wind bulkhead, in particular by using corresponding upholstery.

According to embodiments of the invention, a particularly expedient design is produced for the wind bulkhead device if the wind bulkhead is assigned a base plate, and the wind bulkhead can be displaced in relation to the base plate between its upright bulkhead position and a horizontal folded-down position, in which the wind bulkhead extends essentially parallel to the base plate.

The position of the wind bulkhead device with respect to the seats can also be defined in a simple manner via the base plate, with a particularly expedient solution consisting in that the base plate can be supported and optionally can also be fixed on the upper side sections of the backrest of the adjacent seats, which upper side sections protrude laterally with respect to the head restraints. To secure the position of the base plate, with reference to an initial construction of the vehicle according to the invention, in which the seats provided laterally adjacent to the wind bulkhead are assigned to the rear boundary of the vehicle passenger compartment, a solution has proven particularly expedient. In this exemplary solution, the base plate is arranged in a hinged manner to the rear side of this rear passenger compartment boundary, such that, when the wind bulkhead is folded down onto the base plate, the base plate together with the wind bulkhead can be pivoted in against the rear side of the rear boundary.

The hinge arrangement to be provided for this purpose is designed, in particular, as a hinge with two parallel hinge axes connected via a web, with it being possible to provide one or more of such wing hinges in order to attach the base plate. In conjunction with the use of such wing hinges, it can firstly be ensured in a simple manner that, when the base plate is pivoted to the rear into the storage position, the wind bulkhead is located between the base plate and the rear side of the rear boundary, and is therefore protected. Secondly, the base plate can advantageously be fixed with respect to the pivot axis assigned to it, of the wing hinge in the support position, corresponding to the folded-down position of the wind bulkhead, with respect to the upper sides of the backrests of the seats by the web of the wing hinge being fixed.

This embodiment can advantageously be combined with the function of other parts of the vehicle construction if, for example, the space on the rear side for the rear boundary of the vehicle passenger compartment is assigned a covering which, in its closed position, fixes the web of the wing hinge. For this purpose, the covering can be correspondingly pivoted in or else displaced longitudinally such that the fixing of the web of the wing hinge can be achieved by a clamping action.

### BRIEF DESCRIPTION OF THE DRAWINGS

Further exemplary details and features of the invention are described in the following specification and claims. Furthermore, the invention is explained below with further details with reference to an exemplary embodiment, in which:

FIG. 1 shows a perspective oblique view from the top rear of a vehicle provided with an open bodywork with an open folding top, the illustration being restricted to the rear part of the rear seat region and the rear region which adjoins it on the rear side and is provided with a covering, with a wind protection arrangement which is situated in the space between the head restraints assigned to the rear seats, and the wind bulkhead of which assumes its upright bulkhead position;

FIG. 2 shows an illustration corresponding to FIG. 1 with the wind bulkhead illustrated in the folded-down position; and

FIG. 3 shows an illustration corresponding to FIG. 2, with the rear wall region of the passenger compartment being illustrated in a manner such that it is visible from the rear.

### DETAILED DESCRIPTION OF THE DRAWINGS

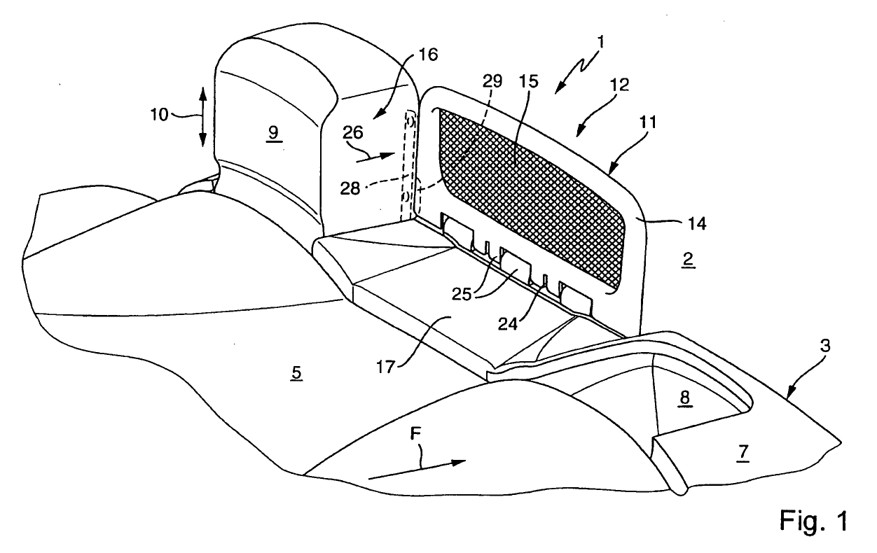

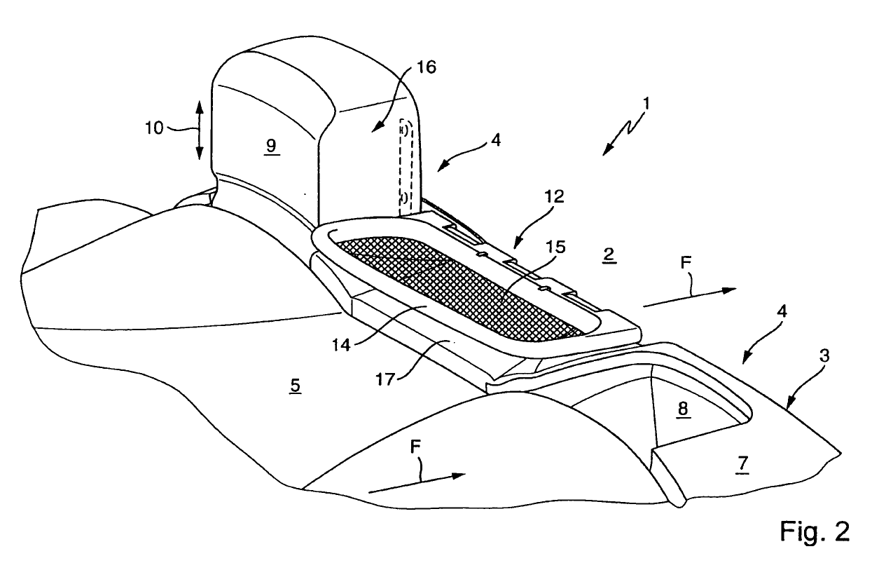

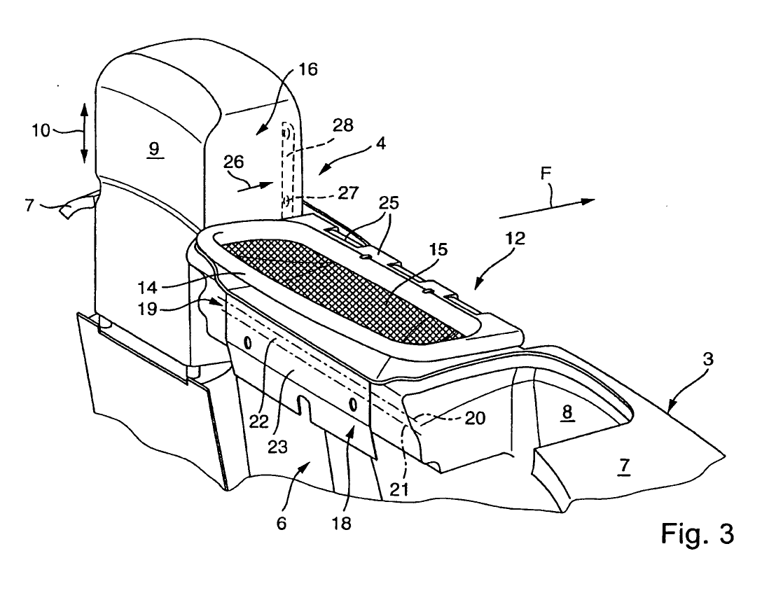

In the drawings, F denotes the forward direction of travel of a vehicle 1, of which only an excerpt is illustrated which comprises the rear wall region of the passenger compartment 2 with the backrests 3 of the rear seats 4, and the region which is adjacent on the rear side to the rear wall 6 and which is covered in FIGS. 1 and 2 by a covering 5, while FIG. 3 shows the rear wall 6 in a rear view.

The backrests 3 of the rear seats 4 are assigned to the rear wall 6 which delimits the passenger compartment 2 to the rear and is upwardly covered in the region of the rear seats, which are situated next to each other in the transverse direction of the vehicle, by the upper sides 7 of the backrests 3, which sides have cutouts 8 for head restraints 9, Of the head restraints 9, only the one assigned to the left rear seat 4 is illustrated in the figures, while the cutout 8 in the upper side 7 of the backrest 3 is shown on the right rear seat 4.

The head restraints 9 can preferably be displaced in the vertical direction, as shown by the arrow 10, and can be lowered from the extended position, shown for the left head restraint 9, into a position in which the upper top surface of the respective head restraint 9 is situated approximately in the plane of the respective upper side 7 of the backrest 3 (not shown).

The head restraints 9 are narrower than the backrests 3 and, in the space between the head restraints 9, of which the right one is not illustrated, a wind bulkhead device 12 is provided. The wind bulkhead device 12 comprises a wind bulkhead 11 which, in the exemplary embodiment, comprises a net 15, which is spread out in a frame 14, and which is shown in its erected bulkhead position in FIG. 1 and in a folded-down position in FIGS. 2 and 3. In its upright bulkhead position, the wind bulkhead 11 extends approximately in a plane with the front sides of the head restraints 9, laterally adjacent to the mutually facing side surfaces 16 of the head restraints 9 and in a hinged coupling to a base plate 17 which is supported on the upper sides 7 of the backrests 3, in their edge regions running opposite each other and emerging from the backrests 9.

The wind bulkhead 11 can be pivoted from its bulkhead position to the rear into a folded-down position against the base plate 17 (FIGS. 2 and 3), with the base plate 17 being fixed to the rear wall 6 via a fastening region 18 which protrudes downward on the rear side from the base plate 17 and is connected in a hinged manner to the base plate 17.

This hinge connection 19 is preferably designed, as FIG. 3 shows schematically, in the manner of a wing hinge and comprises two hinge axes 20 and 21 which extend parallel to and at a distance from each other, and between which a connecting web 22 is situated such that, via the hinge connection 19, the base plate 17 with the wind bulkhead 11 lying thereon can be pivoted in downward into the space behind the rear wall 6. In this pivoted-in position, the fastening strip 23 of the fastening region 18, which strip is connected to the rear wall 6, lies approximately parallel to the downwardly pivoted base plate 17 and the wind bulkhead 11, which is connected to the base plate 17, adopts a position between the fastening strip 23 and the base plate 17. Therefore, the base plate 17 delimits the wind bulkhead 11 with its net 15 from the space which is situated on the rear side of the rear wall 6 and preferably serves as a storage space for the particular folding top of the vehicle and/or as a trunk.

The wind bulkhead 11 is preferably supported resiliently against the base plate 17, with the springs of the support 24 preferably being formed by leg springs which are firstly supported against the base plate and secondly against the frame 14 of the wind bulkhead 11.

The hinge connection between the wind bulkhead 11 and the base plate 17 is indicated by hinge tabs 25. Also not shown is that the wind bulkhead 11 is assigned a stop limitation which limits the pivoting path in the direction of the erected bulkhead position. This stop limitation is preferably integrated into the hinge connection between wind bulkhead 11 and base plate 17, but can also be provided elsewhere between base plate 17 and wind bulkhead 11.

In additional exemplary embodiments of the invention, there is a correspondingly spring-actuated support between the head restraints 9 and the wind bulkhead 11 in the bulkhead position thereof, with it being possible to provide such a support in particular for load relief and stabilization, and as a supplement to a stop limitation between base plate 17 and wind bulkhead 11.

It is furthermore indicated in schematized form in the figures that the side surfaces 16 of the head restraints 9 are assigned knock-over resistance elements 26, shown as latching cams 27 and/or—by dashed lines—as latching beads 28, the knock-over resistance elements 26 being configured in such a manner that, when the wind bulkhead 11 is pivoted up into its bulkhead position, the resistance elements 26 can be knocked over on account of the elastic flexibility and, in the bulkhead position of the wind bulkhead 11, engage behind the frame of the latter or engage in its frame.

Latching cams 27 or latching beads 28 serve only to show exemplary knock-over resistance elements 26, since it is also possible within the scope of the invention to design the side surfaces 16 entirely or in some regions to be elastic in such a manner that, when the wind bulkhead 11 is erected, they are pushed back by the latter and, when the wind bulkhead 11 is in the bulkhead position, support its frame on the rear side.

FIGS. 1 and 2 show, on the rear side of the base plate 17, a covering 5 which can be formed, for example, by a folding-top compartment flap. The latter is preferably mounted in such a manner or else is displaceable, at least over an end region, linearly in the direction of the rear wall 6 in such a manner that the connecting web 22 and/or the base plate 17 is/are acted upon and preferably clamped in the direction of travel F by the covering 5. Such a construction permits stabilization of the wind protection arrangement 1 when the wind bulkhead 11 is in the bulkhead position or folded-down position, using components which are already present.

Furthermore, the connection according to the invention of the wind protection arrangement to the rear wall 6 makes it possible to transfer the wind protection arrangement as a whole into a position in the storage space behind the rear wall 6, in which it is covered by the covering 5 such that the wind bulkhead device can also be secured against theft and withdrawn from sight. Stabilization of the wind protection arrangement can also be achieved via the covering 5 by supporting it against the covering 5, for example by the covering 5 being assigned a stop strip or the like via which the wind bulkhead device is supported in the folded-down state in the direction of the rear wall 6. A corresponding support in the vertical direction can take place directly via the covering 5, with the covering 5 then preferably extending over the connecting web 22.

The pivoting of the wind bulkhead 11 from its bulkhead position into the folded-down position can preferably also be combined, within the scope of the invention, with the lowering of the head restraints 9 which may be remotely actuable in a known manner. If the head restraints 9 are lowered, then the support of the wind bulkhead 11 provided by the knock-over resistance elements 26 is unnecessary, and the wind bulkhead 11, if correspondingly preloaded, can be pivoted, for example upon corresponding actuation by spring force, but also manually, into the folded-down position. In the folded-down position of the wind bulkhead 11, an extension of the head restraints 9 is possible, irrespective of the knock-over resistance elements 26 assigned to their side surfaces 16. The frame region of the wind bulkhead 11 which is adjacent to the pivot axis of the wind bulkhead 11 and, in the folded-down position, is thus located covering the knock-over resistance elements 26, and is thus preferably somewhat released or drawn back, which is indicated in FIG. 1 by the dashed line 29. If the head restraints 9 also satisfy a roll bar function, it is thereby also ensured that, in the event of triggering, the head restraint or the roll bar formed by the latter can extend without being obstructed.

1-27. (canceled)

28. A wind bulkhead device for a motor vehicle provided with an open bodywork and two vehicle seats arranged next to each other in the transverse direction of the vehicle; comprising:
a wind bulkhead which, in an upright bulkhead position, extends between mutually facing sides of head restraints assigned to the two vehicle seats and arranged above backrests of the two seats;
stops supporting the wind bulkhead in the erection direction when in the upright bulkhead position; and
knock-over resistance elements disposed on the facing sides of the head restraints for securing the wind bulkhead in an opposite direction; wherein
the wind bulkhead is repositionable from the upright bulkhead position to a folded-down position in which it is pivoted to the rear.

29. The wind bulkhead device as claimed in claim 28, wherein the head restraints are extendable with respect to the backrests.

30. The wind bulkhead device as claimed in claim 28, wherein the head restraints are lowerable against the backrests.

31. The wind bulkhead device as claimed in claim 30, wherein the head restraints are retractable into the backrests.

32. The wind bulkhead device as claimed in claim 30, wherein the wind bulkhead is positionable from the upright bulkhead position into the folded-down position by lowering the head restraints against the backrests.

33. The wind bulkhead device as claimed in claim 28, wherein the wind bulkhead is spring-loaded in the pivoting direction to the folded-down position.

34. The wind bulkhead device as claimed in claim 28, wherein, in the upright bulkhead position, the wind bulkhead extends substantially along a plane defined by front sides of the head restraints.

35. The wind bulkhead device as claimed in claim 28, wherein the mutually facing side surfaces of the head restraints comprise elastically flexible regions extending into a pivoting region of the wind bulkhead to define the knock-over resistance elements.

36. The wind bulkhead device as claimed in claim 28, wherein the knock-over resistance elements comprise elastic bead-like protrusions disposed on the side surfaces of the head restraints.

37. The wind bulkhead device as claimed in claim 28, wherein the knock-over resistance means comprise catches disposed on the side surfaces of the head restraints.

38. The wind bulkhead device as claimed in claim 37, wherein the catches comprise latching cams.

39. The wind bulkhead device as claimed in claim 37, wherein the catches are spring-loaded.

40. The wind bulkhead device as claimed in claim 28, wherein the wind bulkhead is pivotable against a base plate.

41. The wind bulkhead device as claimed in claim 40, wherein the wind bulkhead is supported via the base plate.

42. The wind bulkhead device as claimed in claim 40, wherein the base plate extends between the head restraints, substantially level with upper sides of the backrests.

43. The wind bulkhead device as claimed in claim 28, wherein the head restraints are narrower in the transverse direction of the vehicle than the backrests.

44. The wind bulkhead device as claimed in claim 40, wherein the base plate, pivotally receiving the wind bulkhead displaceable between the upright bulkhead position and the folded-down position, rests on upper sides of the backrests.

45. The wind bulkhead device as claimed in claim 28, wherein the seats connected by the wind bulkhead comprise a driver's seat and a passenger's seat of a two-seater vehicle.

46. The wind bulkhead device as claimed in claim 28, wherein the seats connected by the wind bulkhead comprise rear seats of a four-seater vehicle.

47. The wind bulkhead device as claimed in claim 40, wherein the base plate forms a covering extending between the head restraints, substantially level with upper sides of the backrests of the seats.

48. The wind bulkhead device as claimed in claim 40, wherein the wind bulkhead is arranged along a front edge of the base plate, extending between the head restraints.

49. The wind bulkhead device as claimed in claim 40, wherein the base plate is coupled on a rear side to a rear boundary of a passenger compartment of the vehicle.

50. The wind bulkhead device as claimed in claim 40, wherein the wind bulkhead is pivotable downward against a rear wall of a passenger compartment of the vehicle.

51. The wind bulkhead device as claimed in claim 50, wherein the base plate supporting the wind bulkhead is connected to the rear wall of the vehicle passenger compartment via a hinge connection having two pivot axes which are parallel to each other and are spaced apart from each other.

52. The wind bulkhead device as claimed in claim 51, wherein a web of the hinge connection, the web being situated between the two pivot axes, extends transversely to a rear vehicle covering and, by movement of the rear vehicle covering when the base plate is in a covering position, is fixable via the rear covering.

53. The wind bulkhead device as claimed in claim 28, wherein the head restraints provide a roll bar function.

54. The wind bulkhead device as claimed in claim 53, wherein the head restraints are repositionable from a lowered position relative to the wind bulkhead into an extended position without being obstructed.
